(19) United States
(12) Patent Application Publication
(10) Pub. No.: US 2002/0139521 A1
(43) Pub. Date: Oct. 3, 2002

(54) Aluminum based collared header plate for a heat exchanger, especially for a motor vehicle

(76) Inventors: Frederic Letrange, Nanterre (FR); Carlos Martins, Montfort L' Amaury (FR)

Correspondence Address: MORGAN & FINNEGAN, L.L.P., 345 Park Avenue, New York, NY, 10154-0053, US

(21) Appl. No.: 10/151,884

(22) Filed: May 22, 2002

Related U.S. Application Data
(62) Division of application No. 08/918,439, filed on Aug. 26, 1997.

(30) Foreign Application Priority Data
Aug. 29, 1996 (FR) 96.10573

(51) Int. Cl. B23P 15/26; B23C 1/00; F28F 1/32

(52) U.S. Cl. 165/171; 29/890.052

(57) ABSTRACT

An aluminum based header plate, for a tubular heat exchanger for a motor vehicle, has an external coating on its outer face. An end portion of each heat exchanger tube is received in a corresponding through hole in the header plate. The tube end portions have a predetermined cross section and an external coating, and secured to the header plate by brazing. Each through hole is made by a slitting operation followed by configuration of the through hole within a selected zone of the header plate, this zone being press-formed so as to form in the outer face of the header plate a collar portion in that zone. The internal transverse cross section of each collar portion is substantially identical to the predetermined cross section of the corresponding tube end portion. After the tube has been introduced into the through hole, which extends through the collar portion, there is surface contact between the respective external coatings of the collar portion and of the tube end portion.

### FIELD OF THE INVENTION

This invention relates to heat exchangers, especially for motor vehicles. More particularly, the invention relates to header plates for such heat exchangers, where the header plate is of an aluminum based material and has an outer surface covered with an external coating, and a plurality of through holes, each of which is adapted to receive an end portion of a heat exchanger tube, the tube end portion having a predetermined cross section and having a further external coating.

### BACKGROUND OF THE INVENTION

At the present time, in such aluminum based header plates, the tubes are secured to the header plate, in the region of the through holes in the latter, by welding or brazing. The through holes in this type of header plate are generally made by a press-forming operation which involves removal of some material. The contact between the end portion of a tube, having an external coating, and the header plate, is consequently obtained over the periphery of the through hole into which the tube end portion is introduced. This contact accordingly occurs in the thickness of the wall of the header plate, that is to say precisely in the region where the latter, as a result of the pressing-out operation, no longer has a reliable coating.

The result of this is that the brazed or welded joint between each tube and the corresponding through hole in the header plate gives less than perfect sealing. This can later give rise to leakage and corrosion problems, the consequences of which can be serious.

In addition, because of weight and size limitations which are encountered in the engine compartments of current vehicles, manufacturers are obliged to make use of light and thin materials. Now, thin materials such as are used at the present time do not always have the required mechanical strength characteristics, in particular as regards ability to withstand pressure cycling.

In order to overcome this disadvantage, some header plates are made of an alloy of aluminum and magnesium, which has a better mechanical strength than that of pure aluminum. However, it has become apparent that during the brazing operation some of the magnesium tends to diffuse towards the brazed joint, thus reducing the ability of the surfaces to be brazed together to be wetted. This results in a significant reduction in the effectiveness of sealing in the brazed joint, and this, again, can give rise to leakage and accelerated corrosion.

### DISCUSSION OF THE INVENTION

An object of the invention is to provide a header plate of aluminum based material, of the general kind defined in “Field of the Invention” above, which does not have the above mentioned drawbacks.

According to the invention in a first aspect, a header plate of aluminum based material for a heat exchanger, especially for a motor vehicle, the said header plate having an outer surface coated with an external coating, and further having a multiplicity of through holes, each of which is adapted to receive an end portion of a heat exchanger tube of predefined cross section, clad on the outside with an external coating, is characterised in that each through hole is formed by slitting a selected zone of the header plate followed by a configuring operation, the said zone being deformed by press-forming in such a way that the outer surface of the header plate bounds, in the said zone, a collar portion having an internal transverse cross section which is substantially identical to the predefined cross section of the corresponding said tube end portion, so that after introduction of the tube into the through hole in the collar portion, a surface contact is obtained between the respective external coatings of the collar portion and the tube end portion.

In this specification, the term “slitting” is to be taken to mean the particular form of piercing that does not involve removal of any material. In the context of the present invention, this slitting operation facilitates the formation of the collar portion, thus enabling an excellent seal to be obtained by brazing.

Preferably, the external coatings of the header plate and tube end portions are of an alloy of aluminum and silicon.

Preferably, the inner face of the header plate, which is opposed to its outer face, is covered with an internal coating which may for example be an alloy of aluminum and zinc, the anti-corrosive properties of which are well known. This enhances the protection of the heat exchanger against corrosion.

In a preferred embodiment of the invention, the header plate is made in an alloy of aluminum and magnesium, the percentage of magenesium being preferably greater than 2%. This leads to a substantial improvement in the mechanical strength of the header plate as compared with a header plate made of pure aluminum.

According to another feature of the invention, an intermediate coating is provided between the outer face of the header plate and its external coating, this intermediate coating being for example in an alloy of aluminum and zinc. The intermediate coating restricts, and can even totally prevent, the diffusion of magnesium towards the external coating, and therefore helps to improve even more the quality of the seal given by the brazed joint.

In a second aspect of the invention, a method of forming the through holes in a header plate according to the said first aspect of the invention is characterised in that it comprises the following steps:

(a) providing a tool which comprises: a punch having a sharp end portion extended by a body having a transverse cross section substantially identical to that of a said tube end portion; and a die formed with at least one die hole having a cross section substantially equal to the transverse cross section of the body of the corresponding punch added to the thickness of the header plate;

(b) locating the die in facing relationship with an inner surface of the header plate, opposed to its outer surface, so that the said die hole lies above a selected zone of the header plate, and then applying the sharp end portion of the punch on the outer surface of the header plate in the selected zone, so as to cause the internal surface of the header plate to penetrate into the die hole; and

### BRIEF DESCRIPTION OF THE DRAWINGS

FIG. 1A shows a first step in the manufacture of a header plate in accordance with the invention, seen in longitudinal cross section.

FIG. 1B shows in longitudinal cross section a second step in the manufacture of the header plate.

FIG. 1C shows the same second step, but in transverse cross section.

FIG. 1D shows a third step in the manufacture of the header plate, in transverse cross section.

FIG. 1E shows the same third step in longitudinal cross section.

FIG. 2 is a top plan view of a punch for making the holes in a header plate according to the invention.

FIG. 3 shows, in transverse cross section, a first embodiment of the header plate according to the invention, equipped with heat exchanger tubes.

FIG. 4A shows in transverse cross section a header plate according to the invention in a second embodiment, equipped with a heat exchanger tube.

FIG. 4B is a scrap view repeating, on a larger scale, that part of FIG. 4A which is denoted by a phantom circle.

### DESCRIPTION OF PREFERRED EMBODIMENTS OF THE INVENTION

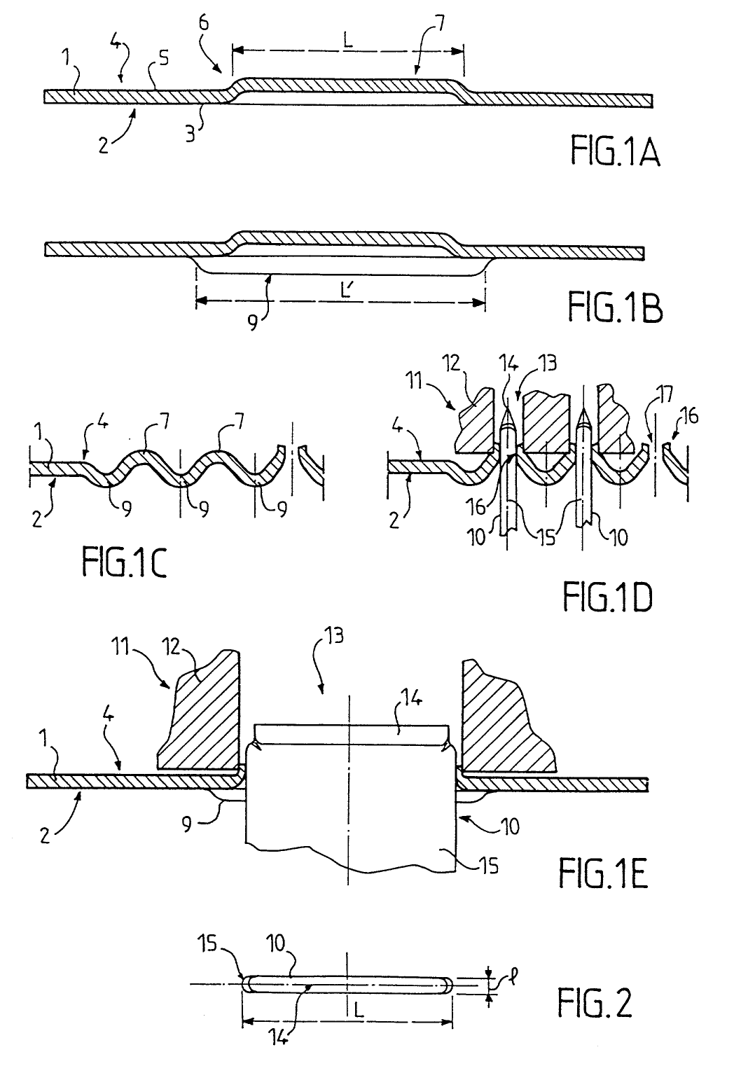

Reference is first made to FIGS. 1A to 1E, and FIG. 2. The main steps in a method of forming holes in an aluminum based header plate will be described with reference to these Figures.

The starting point for making the header plate is a substantially flat plate 1, of aluminum or an aluminum alloy. The outer face 2 of the plate has an external coating 3, which is preferably of an alloy of aluminum and silicon. Preferably the inner face 4 is also coated, in this case with an anti-corrosion material such as an aluminum zinc alloy.

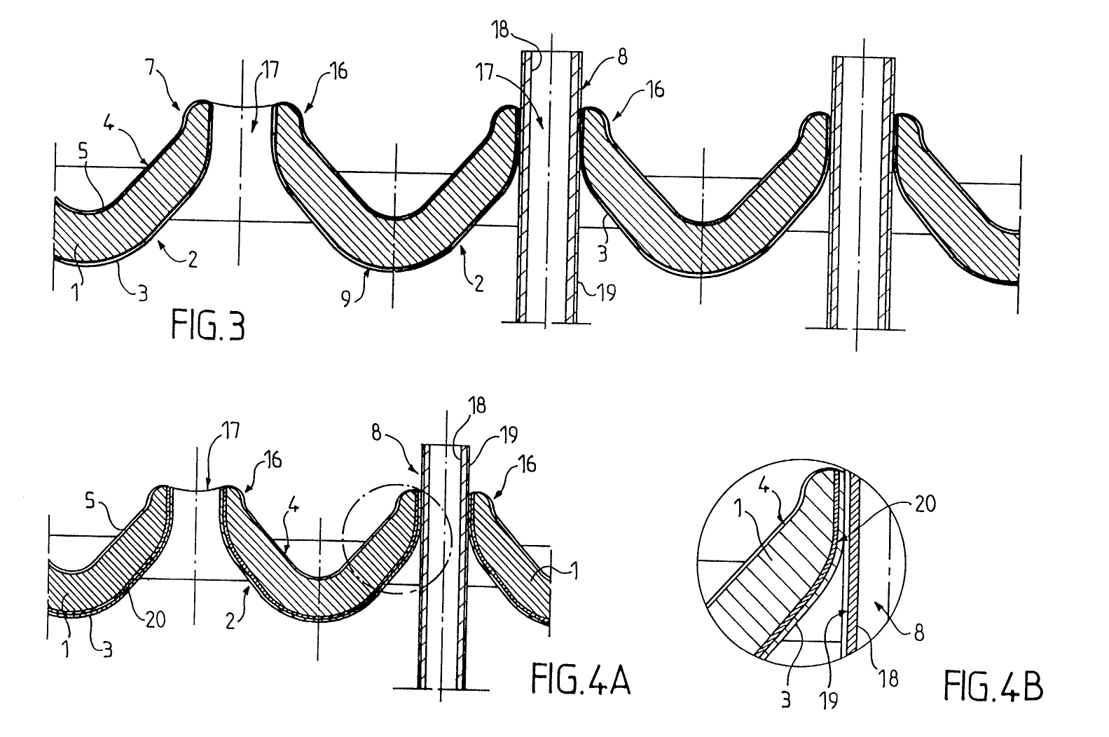

Using an appropriate machine tool, a central portion 6 of the plate 1 is then press-formed so as to create in this central zone a first offset portion, or blister, 7, which is in relief on the same side as the inner face 4 of the plate. This first blister 7 has dimensions which are substantially equal to the dimensions of the end portion 8 of a heat exchanger tube (see FIG. 3) and the dimensions of a punch shown in FIG. 2. This punch is used for forming through holes in the plate 1. Further reference will be made to these holes later in this description. The first offset portion or blister 7 is substantially oval in form, having a major or longitudinal side L and a minor or transverse side I. This first offset portion is seen in longitudinal cross section in FIG. 1A.

The next step, shown in FIGS. 1B and 1C, is again a press-forming step, in which a second offset portion 9 is formed, this time in relief on the outer face 2 of the plate 1. The second offset portion surrounds at least part of the first offset portion 7, so as to form two grooves, at least on the longitudinal sides L of the offset portion 7. The groove that lies between two parallel blisters 7 adjacent to each other does of course constitute a second offset portion 9 for each of the two offset portions 7 concerned. The length L′ of the longitudinal extent of the second offset portion 9 is substantially greater than the length L of the portion 7.

It will of course be understood that the first and second offset portions 7 and 9 may be formed in a single step, using an appropriate machine tool.

In the third step illustrated in FIGS. 1D and 1E, a further tool 11 is used. The tool 11 comprises at least one punch 10 (there being two of these punches in the example shown in FIG. 1D), together with a die 12 having as many die holes 13 as there are of the punches 10, with one die hole 13 corresponding to each punch 10 so that the punches 10 can slide within the die holes.

Each punch 10 has a sharp and tapered end portion 14, which is extended by a body 15 of the punch having a transverse cross section which is substantially identical to that of the first offset portion or blister 7 and to the outer transverse cross section of a tube end portion 8. In the die 12, each die hole 13 has a form which is matched in shape to that of the body 15 of the corresponding punch 10, but which is slightly larger for reasons which will be explained later in this description.

The holes 17 in the plate 1 are formed in the following way. The die 10 of the tool 11 is first positioned in such a way that each of its die holes 13 lies above a corresponding one of the first offset portions 7 and in contact with the inner face 4 of the plate 1. The punches 10 are then displaced substantially at right angles to the plane defined by the plate 1, and parallel to the axes of the die holes 13, until the respective end portions 14 of the punches make contact with the profiled outer face 2 of the plate at the locations of the first offset portions 7. The plate 1 is then slit by means of the sharp ends 14 of the punches without removing any material, thereby rough forming the through holes 17.

The body 15 of each punch 10 is then forced through the rough-formed opening, and the punch continues to be moved so as to slide within the die hole 13 (as can be seen in FIGS. 1D and 1E). Because of the dimensioning of the die hole 13, some of the material of the plate 1 is carried by the punch 10 into the interior of the corresponding die hole 13, thus forming an upset collar portion 16, the dimension of which is equal to the transverse cross section of the body 15 of the punch 10. This also configures the actual hole 17, which was previously rough-formed by the slitting operation described above, to the dimensions of the punch body 15, and therefore also configures the hole 17 to the dimensions of the tube end portion 8 to be received in the hole 17.

The central portion 6 of the header plate 1 having thus been formed with its through holes, the tube end portions 8 can now be introduced into these holes as shown in FIG. 3. Once the tube end portions have been fitted in their precisely dimensioned holes 17, surface contact is made between the external coating 3 on the outer face 2 of the header plate 1, which bounds the collar portions 16, and the external coating 19 on the tube wall 18 in the end portion 8 of the tube, see FIG. 3. This surface contact takes place over several millimetres of height, so that during the subsequent brazing step, a very good sealing joint can be obtained.

Reference is now made to FIGS. 4A and 4B, to describe another version of header plate in accordance with the invention.

Because of the comparative fragility of header plates made of pure aluminum, the latter may be made of an alloy of aluminum and magnesium. The percentage of magnesium in such an alloy is preferably greater than 2%. This type of header plate has significantly better mechanical strength than that of header plates made of pure aluminum. However, the magnesium contained in the alloy tends to diffuse during the brazing operation, in particular towards the external coating 3, and this tends to diminish the effectiveness of the seal in the brazed joint by reducing the ability of the external coating on the outer face 2 to be wetted.

Consequently, it is preferable to place, between the external coating 3 and the plate of aluminum and magnesium alloy that constitutes the header plate 1, an intermediate coating 20 of an aluminum and zinc alloy, the physical characteristics of which enable the diffusion of the magnesium towards the external coating 3 to be at least limited, and even to be fully prevented. In this way, header plates can be made with high sealing integrity, and with mechanical characteristics which enable them to withstand very high cyclic pressures.

The invention is not limited to the embodiments of header plate and methods of making it described above, but embraces all those variants which could be conceived by a person normally skilled in the art within the scope of the Claims of this Application.

Thus, for example, although a header plate has been described in which the through holes are formed after the formation of offset portions, namely, in the above example, the first offset portion 7 and the second offset portion 9, it will be understood that these offset portions, though preferred, are not in fact essential.

In addition, in the method described above, the through holes are first rough-formed by slitting without any removal of material. However, it is perfectly well possible to envisage the holes being rough-formed by slitting with some removal of material, provided that the rough-formed hole is of substantially smaller dimensions than a tube end portion, so that integral collar portions can be formed.

What is claimed is:

1. A heat exchanger comprising a plurality of heat exchanger tubes and an aluminum based header plate, the header plate having an outer face and a first external coating covering the said outer face, the header plate further having a plurality of through holes each receiving an end portion of a corresponding one of the said tubes, each said tube end portion having a predetermined cross section and including a second external coating, wherein the header plate further includes an integral collar portion surrounding each said through hole, each said collar portion having an internal transverse cross section substantially identical to the predetermined cross section of the corresponding said tube end portion, with the first external coating extending on the collar portion, each tube end portion extending through the corresponding said collar portion with the said first coating being in surface contact with the second coating within each collar portion.

2. A heat exchanger according to claim 1, wherein the said first and second external coatings are of an alloy of aluminum and silicon.

3. A heat exchanger according to claim 1, wherein the header plate further has an inner surface opposed to the said outer surface, and an internal coating covering the said inner surface.

4. A heat exchanger according to claim 3, wherein the said internal coating is of an alloy of aluminum and zinc.

5. A heat exchanger according to claim 1, wherein the header plate is made of an alloy of aluminum and magnesium.

6. A heat exchanger according to claim 5, wherein the said alloy of aluminum and magnesium contains more than 2% magnesium.

7. A heat exchanger according to claim 1, wherein the header plate further includes an intermediate coating interposed between its external surface and the first external coating.

8. A heat exchanger according to claim 7, wherein the said intermediate coating is of an alloy of aluminum and zinc.

9. A method of making an aluminum based header plate for a heat exchanger comprising a plurality of heat exchanger tubes and the said header plate, in which each said tube has an end portion of predetermined cross section, the header plate having an outer face and an inner face, said outer facing having a first external coating, the header plate further having a plurality of through holes each of which is adapted to receive a corresponding said tube end portion, each tube end portion having a second external coating, wherein the method includes the steps of:
(a) providing a tool consisting of a punch and a die, the punch comprising a body having a transverse cross section substantially identical to that of a said tube end portion, the punch body terminating in a sharp end, and the die having at least one die hole with a cross section substantially equal to the transverse cross section of the corresponding punch body added to the thickness of the header plate between said outer and inner faces thereof;
(b) selecting a zone of the header plate for formation of a said through hole in the selected zone; locating the die in facing relationship with the inner face of the header plate, with the said die hole over the said zone; and applying the sharp end of the punch to the outer face of the header plate in the said zone so that the said sharp end penetrates the inner face of the header plate in the die hole; and
(c) slitting the said zone to rough-form a said through hole and cause the material of the header plate bounding the said through hole to penetrate into the die hole, thereby forming a collar portion; then causing the punch body to slide in the die hole so as to form an internal transverse cross section of the collar portion and the through hole bounded thereby, which is substantially identical to the predetermined cross section of a said tube end portion; fitting the said tube end portion into the through hole; and securing the tube end portion to the header plate.

10. A method according to claim 9, wherein the said zone is slit by a punching operation without removal of any material.

11. A method according to claim 9, further including the additional steps, after step (a) and before step (b), of:
press-forming the selected zone of the header plate from the same side of the header plate as its outer face, thereby forming in relief on the said inner face of the header plate a first offset portion of dimensions substantially equal to those of the punch body; and then
press-forming, from the same side as the inner face of the header plate, a second offset portion in relief on the said outer face, such that the said second offset portion at least partly surrounds the first offset portion.
